(19) United States
(12) Patent Application Publication
(10) Pub. No.: US 2006/0120236 A1
(43) Pub. Date: Jun. 8, 2006

(54) Apparatus and methods for writing data to an optical medium

(75) Inventor: Seungjae Chung, Suwon city (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/280,677

(22) Filed: Nov. 16, 2005

(30) Foreign Application Priority Data
Dec. 3, 2004 (KR) 10-2004-0100935

(51) Int. Cl. G11B 5/09

(52) U.S. Cl. 369/47.1; 369/59.1

(57) ABSTRACT

In an apparatus and method for writing data to an optical medium, a optical medium write operation can be recovered with high reliability and precision in the event that it is abnormally interrupted. This is possible even in the case where the physical address of the medium is irreparably damaged, by recoding a data identifier and data identifier latency value of the last data segment written to the medium. The apparatus and methods of the present invention are especially advantageous for write operations to single-write media, since they reduce the frequency of discarded media.

### RELATED APPLICATIONS

This application claims priority under 35 U.S.C. 119 to Korean Patent Application No. 10-2004-0100935, filed on Dec. 3, 2004, the disclosure of which is incorporated herein by reference in its entirety.

### BACKGROUND OF THE INVENTION

1. Field of the Invention

The present invention relates to an optical media writing apparatus and method, and particularly, to an apparatus and method in which a writing operation of an optical medium that is abnormally interrupted is recovered at the precise location on the medium at which the writing operation was halted.

2. Description of the Related Art

In conventional optical media writing apparatus, interruptions can occur during a writing operation. For example, interruptions can occur due to phenomena such as an applied shock or force, unavailability of write data due to buffer underrun, motor unlock, wobble unlock, and the like. Such interruptions can cause an irrevocable halting of the writing operation.

Optical media are available in several different formats, for example, including CD-R, CD-RW, HD-DVD, BD-DVD, DVD-RW, DVD+RW and DVD-RAM. Different data writing protocols are used for writing data to the medium, depending on the type of medium. For example, DVD−R and DVD−RW media use the Land Pre-bit (LPP) writing method; DVD+R and DVD+RW media use the ADIP writing method, and DVD-RAM media use the Header writing method. The LPP, ADIP, and Header acronyms refer to the types of physical addresses used for these types of media.

In certain optical media formats, such as DVD-RW, DVD+RW, and DVD-RAM, data can be rewritten to the medium a number of times. However, for certain formats, such as CD-R, DVD-R and DVD+R, data can be written to a given location of the medium only a single time. Such media formats are referred to in the art, and herein, as “single-write” optical media.

In the case of a single-write medium, if the writing operation is abnormally interrupted, the conventional writing apparatus can continue to rewrite data to the medium only when the exact location at which the writing of the optical disc writing apparatus ceased is known. For example the LPP, ADIP and Header writing methods mentioned above, will, upon the occurrence of an abnormality during a writing operation, attempt to store the current physical address of the medium at which data is currently being written at the time of the interrupt. During recovery, the writing apparatus references the stored current address and begins writing data at the following physical address.

However, in the event that the physical address of the location being written cannot be accurately recovered during a recovery operation, the writing apparatus cannot continue to write data to the medium, and therefore the medium must be discarded.

### SUMMARY OF THE INVENTION

The present invention is directed to an apparatus and method in which a write operation can be recovered with high reliability and precision in the event that it is abnormally interrupted. This is possible even in the case where the physical address of the medium is irreparably damaged. The apparatus and methods of the present invention are especially advantageous for write operations to single-write media, since they reduce the frequency of discarded media.

In one aspect, the present invention is directed to a system for writing data to an optical medium. A write control unit controls the writing of data segments to an optical medium arranged according to physical addresses, each data segment written to the medium having a data segment identifier and multiple data elements. The write control unit, during a write operation, tracks the data segment identifier of each data segment being written. When a write operation is halted, the write control unit determines the data segment identifier of a last data segment written to the optical medium at the time the write operation is halted. An optical medium read/write unit reads data from the optical medium and determines a data segment identifier associated with the read data, and writes data to the optical medium in response to the write control unit. The write control unit further, following halting of a write operation, causes the read/write unit to read data from the optical medium to locate a last data segment corresponding to the data segment identifier written to the optical medium at the time the writing operation was halted, and recommences writing of data segments to the optical medium at the located last data segment.

In one embodiment, the data segments comprise data frames. In another embodiment, the data segments comprise data sectors. In another embodiment, the data elements comprise data bits of the data segments.

In another embodiment, the system further comprises a register that stores the data segment identifier at the time the write operation is halted.

In another embodiment, the system further comprises a comparator that compares the data segment identifier stored in the register with data segment identifiers read from the optical medium by the read/write unit to locate the last data segment written to the optical medium.

In another embodiment, the write control unit, during a write operation, tracks a data segment latency value representative of the number of data elements of the data segment written relative to the current data segment identifier, and the write control unit, when the write operation is halted, determines the data segment latency value of the last data element written to the optical medium at the time the writing operation is halted.

In another embodiment, the write control unit, following halting of the write operation, further recommences the writing of data segments to the optical medium based on the data segment latency value relative to the data segment identifier of the last data segment. In another embodiment, a register that stores the data segment latency value.

In another embodiment, the write control unit includes a write enable signal control unit that enables a write enable signal when a write operation is being conducted, and disables the write enable signal when a write operation is halted.

In another embodiment, the write control unit, during a write operation, further tracks a physical address of each data segment being written and a physical address latency value representative of the number of data elements of the data segment written relative to the current physical address, and wherein the write control unit, when the write operation is halted, determines the physical address of the last data segment written to the optical medium at the time the writing operation is halted.

In another embodiment, the write control unit, following halting of the write operation, further recommences the writing of data segments to the optical medium based on the physical address latency value relative to the physical address of the last data segment.

In another embodiment, the system further comprises a register that stores the physical address latency value.

In another embodiment, the write operation is halted due to an abnormality or interruption of the write operation.

In another aspect, the present invention is directed to a method for writing data to an optical medium comprising: writing data segments to an optical medium arranged according to physical addresses, each data segment written to the medium having a data segment identifier and multiple data elements; tracking the data segment identifier of each data segment being, written; when a write operation is halted, determining the data segment identifier of a last data segment written to the optical medium at the time the write operation is halted; following halting of the write operation, reading data from the optical medium and determining a data segment identifier associated with the read data to locate a last data segment corresponding to the data segment identifier written to the optical medium at the time the writing operation was halted; and recommencing writing of data segments to the optical medium at the located last data segment.

In one embodiment, the data segments comprise data frames. In another embodiment, the data segments comprise data sectors. In another embodiment, the data elements comprise data bits of the data segments.

In another embodiment, the method further comprises comparing the data segment identifier of the last data segment written to the optical medium with data segment identifiers read from the optical medium to locate the last data segment written to the optical medium.

In another embodiment, the method further comprises, during a write operation, tracking a data segment latency value representative of the number of data elements of the data segment written relative to the current data segment identifier, and when the write operation is halted, determining the data segment latency value of the last data element written to the optical medium at the time the writing operation is halted.

In another embodiment, the method further comprises, following halting of the write operation, further recommencing the writing of data segments to the optical medium based on the data segment latency value relative to the data segment identifier of the last data segment.

In another embodiment, a write enable signal is enabled when a write operation is being conducted, and wherein the write enable signal is disabled when a write operation is halted.

In another embodiment, the method further comprises, during a write operation, tracking a physical address of each data segment being written and a physical address latency value representative of the number of data elements of the data segment written relative to the current physical address, and when the write operation is halted, determining the physical address of the last data segment written to the optical medium at the time the writing operation is halted.

In another embodiment, the method further comprises, following halting of the write operation, recommencing the writing of data segments to the optical medium based on the physical address latency value relative to the physical address of the last data segment.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of a writing operation for an optical medium, that demonstrates the relation between a physical address, a data identifier, a physical address latency value and a data identifier latency value, in accordance with the present invention.

FIG. 2 is a flow diagram of a writing operation of an optical medium writing apparatus, illustrating abnormal halting of a write operation, recording of the data identifier and data identifier latency value, and recovery of the write operation using the same, in accordance with a first embodiment of the present invention.

FIG. 3 is a block diagram of an optical medium writing apparatus for performing a writing operation on an optical medium, in accordance with the first embodiment in the present invention.

FIG. 4 is a flow diagram of a writing operation of an optical medium writing apparatus, illustrating abnormal halting of a write operation, recording of the data identifier and data identifier latency value, recording of the physical address and the physical address latency value, and recovery of the write operation using the same, in accordance with a second embodiment of the present invention.

FIG. 5 is a block diagram of an optical medium writing apparatus for performing a writing operation on an optical medium, in accordance with the second embodiment of the present invention.

### DETAILED DESCRIPTION OF EMBODIMENTS OF THE INVENTION

In contemporary optical media, data are written along a contiguous spiral-shaped track. Segments of the track are identified and distinguished by corresponding physical features along the track. Such physical features are referenced by a physical address that begins at a first feature on the track at a central region of the spiral, and increments with the physical features distributed along the spiral in an outward direction.

A large number of data elements can be written to the track between physical features on a medium. Therefore, a large number of data elements can be assigned to each physical address. In accordance with optical medium protocol, data are arranged in data sectors. A sector of data generally includes a unique data identifier, or “dataID”, followed by a number of data elements arranged in data frames. A data identifier is a form of virtual address that is related to the data stored in that segment, and not to the physical location of the data on the medium.

Depending on the type of media, and the media protocol, the relative sizes of data sectors and frames can vary. For example, DVD-RW media include 16 sectors per physical address, DVD+RW media include 4 sectors per physical address, and DVD-RAM includes 1 sector per physical address.

During a write operation, a write enable signal is active in the conventional optical writing apparatus. When an abnormal interruption occurs, the write enable signal is automatically deactivated. Upon deactivation of the write enable signal, the writing apparatus automatically stores the physical address currently being written. A physical delay value, or physical latency value, representative of the number of bits of data written to the current physical address is also stored by the writing apparatus. The physical latency value is reset when a data element is written to a new physical address, and is incremented upon the writing of each data element to that address.

The conventional media writing apparatus attempts to recover the writing operation in accordance with the stored physical address and the stored physical delay value. This information is used to determine a re-write start location on the medium at which the writing operation can continue. However, often times when the writing operation is abnormally halted, the medium is corrupted, for example the physical feature from which a given physical address is derived can be corrupted when the laser is deflected across the physical feature. Also, over time, the physical feature can become deteriorated. When a physical feature on the medium corresponding to a physical address is corrupted in this manner, recovery of the write operation cannot be secured in the conventional apparatus, since it relies exclusively on physical address information for recovery.

The present invention provides a more accurate system and method for recovering a write operation to an optical medium. In the systems and methods of the present invention, during a write operation, the data identifier and a data identifier latency value for a data element being written to an optical medium are recorded, along with the physical address and physical address latency values of the data element. Upon the deactivation of the write enable signal during a write operation, the data identifier, data identifier latency value, physical address and physical address latency value are used to determine a recovery point for the write operation. The recording of the data identifier and data identifier latency value provides an additional level of detailed information, the use of which allows for more accurate and reliable recovery following an abnormally interrupted write operation to an optical medium, for example a single-write optical medium.

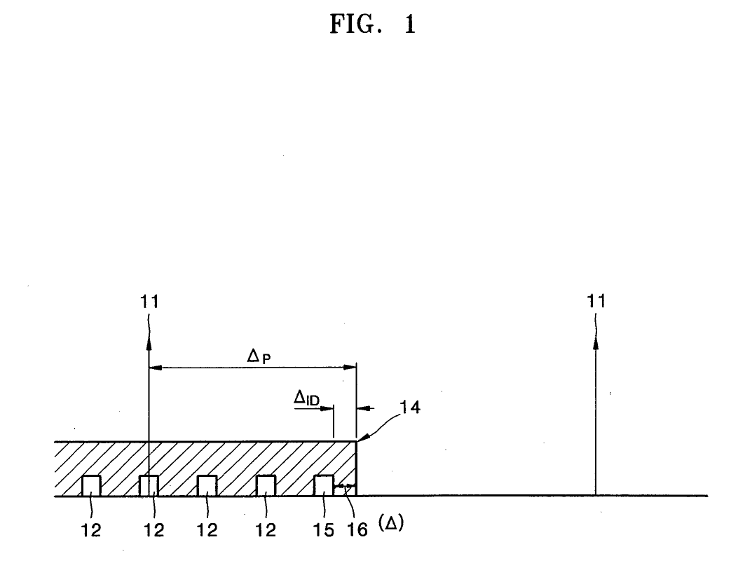

FIG. 1 is an illustration of a writing operation for an optical medium, that demonstrates the relation between a physical address, a data identifier, a physical address latency value and a data identifier latency value, in accordance with the present invention. In FIG. 1, the horizontal axis is representative of data being written in a track of an optical medium during a write operation. Physical features of the track are periodic and are each, when encountered, assigned a unique physical address 11, as shown. Each sector or frame of data written to the track segment assigned to a given physical address 11 is assigned a unique data identifier 12. Following each data identifier 12, corresponding data elements, for example bits of data, are written.

During a write operation, when a physical feature is detected and assigned a unique physical address 11, data sectors or frames are written to the physical address 11. Each data sector of frame comprises a unique data identifier 12 and corresponding data. At the time the physical address 11 is assigned, a physical latency value Δp is reset to a starting value, for example zero. When each data element is written to a given physical address 11, the physical latency value Δp is incremented. The physical latency value Δp is representative of the number of data elements written since the current physical address has been encountered, and can be measured in terms of time, assuming the optical medium spin rate is known, or in terms of a count of the number of data elements. At the same time, upon a new data sector or frame being written with a new data identifier 12, 15, a data identifier latency value Δdi is reset to a starting value, for example, zero. The data identifier latency value Δdi is representative of the number of data elements written since writing of data assigned to the current data identifier 12, 15 has been initiated. Like the physical latency value Δp, the data identifier latency value Δdi can be measured in terms of time, assuming the optical medium spin rate is known, or in terms of a count of the number of data elements.

In the example of FIG. 1, at the time 14 of writing a certain data element 16 assigned to data identifier 15, the writing operation was abnormally interrupted. Upon the deactivation of the write enable signal, the physical address 11 of the data element 16 and the physical latency value Δp are recorded. In addition, in accordance with the present invention, upon deactivation of the write enable signal, the data identifier 15 and the data identifier latency value Δdi are likewise recorded.

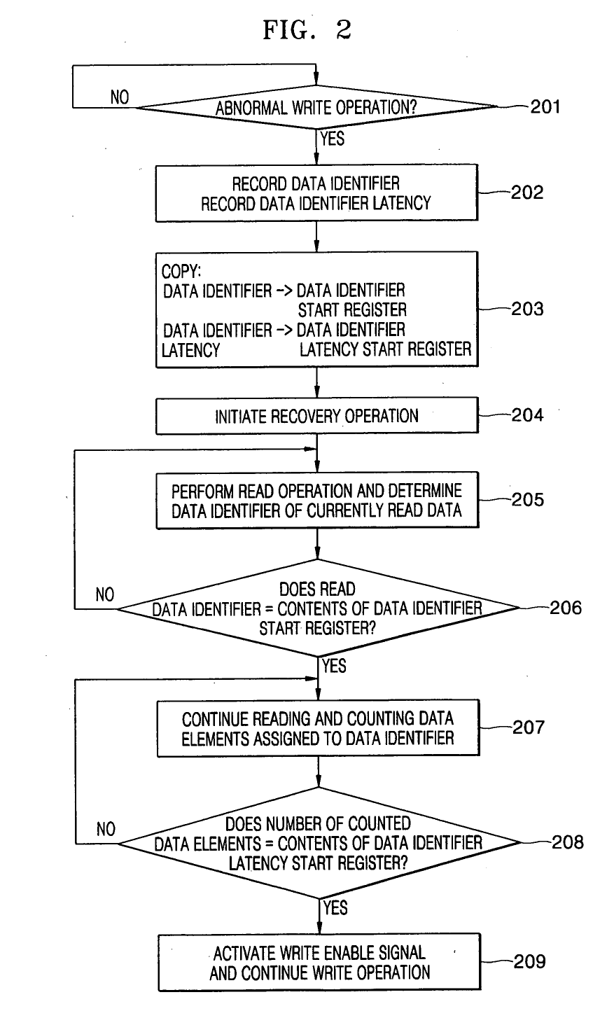

FIG. 2 is a flow diagram of a writing operation of an optical medium writing apparatus, illustrating abnormal halting of a write operation, recording of the data identifier and data identifier latency value, and recovery of the write operation using the same, in accordance with a first embodiment of the present invention.

At step 201, an abnormal write operation is detected, for example by premature deactivation of the write enable signal. At step 202, the data identifier value and the data identifier latency value are recorded.

At step 203, the data identifier value and the data identifier latency value are copied to a data identifier start register and a data identifier latency start register, for later reference during a data write recovery operation.

At step 204, a data write recovery operation is initiated in order to recover the data write operation that was abnormally interrupted. The data write recovery operation attempts to recover the write operation at the location on the medium corresponding to the information recorded in the data identifier start register and the data identifier latency start register. In this manner, the precise physical location at which the write operation was interrupted can be identified, and the write operation can be recovered at that location.

At step 205, a read operation of the medium, referred to sometimes as a “re-read” operation, is performed, for example, beginning at the first physical location of the medium. A data identifier of the currently read data is determined. At step 206, the recorded data are read until the data identifier of the currently read data matches the value stored in the data identifier start register. When this occurs, the read operation continues, and the number of data elements read since the matching data identifier was encountered is tracked at step 207. At step 208, the number of data elements read since the matching data identifier was encountered are counted until the number matches the value stored in the data identifier latency start register. When this occurs, the writing apparatus has properly located the position at which the write operation was abnormally halted. With reference to step 209, the write enable signal is then re-activated and the write operation is continued, leading to a successful recovery of the write operation.

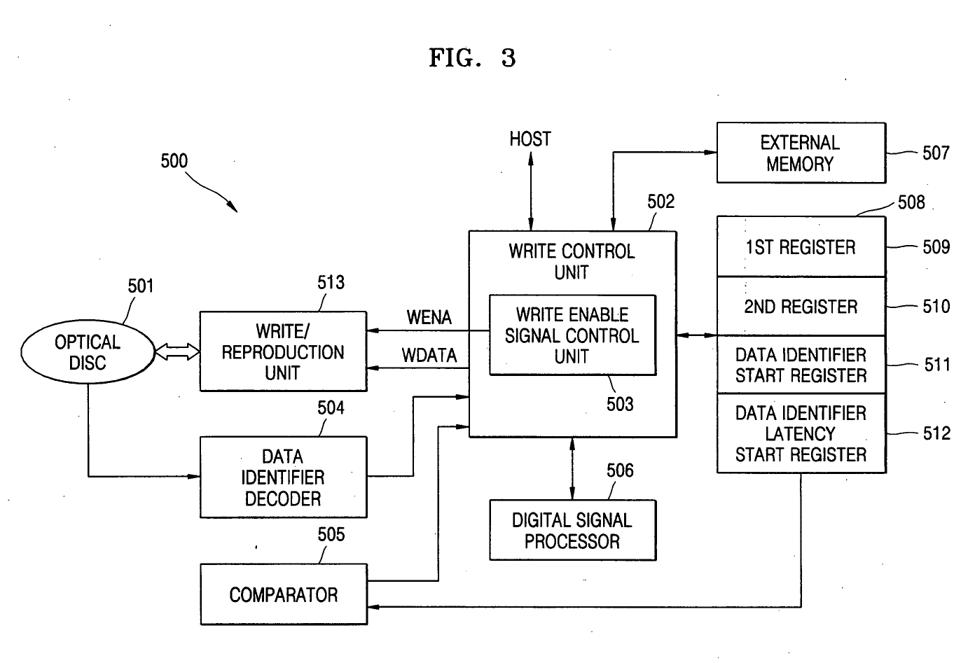

FIG. 3 is a block diagram of an optical medium writing apparatus for performing a writing operation on an optical medium, for example the writing operation of FIG. 2, in accordance with the present invention. The writing apparatus 500 includes a write control unit 502, and supporting digital signal processor 506. The write control unit 502 receives commands from, and sends results to, a host computer HOST. Data are written to and retrieved from an external memory unit 507 that operates as a data buffer for the apparatus 500.

A write/reproduction unit 513 including a data encoder and laser driver is responsive to signals generated by the write control unit 502 for writing data to the optical medium 501. The write control unit includes a write enable signal control unit 503 that generates a write enable signal WENA, also referred to in the art as a “write gate” signal. The write enable signal WENA is active when data are available for writing to the optical medium 501 and when the system is fully operational. When an abnormality occurs during a write operation, such as an abnormality of the type discussed above, the write enable signal WENA is inactivated, and a recovery operation is initiated, as discussed above. Data to be written to the optical medium 501 are forwarded to the write/reproduction unit 513 from the write control unit 502 via data lines WDATA when the write enable WENA signal is active.

A plurality of registers 508 interfacing with the write control unit 502 and digital signal processor 506 include a first register 509 and a second register 510, and a corresponding data identifier start register 511 and a data identifier latency start register 512. As described above with reference to the method described in FIG. 2, the first register 509 is continually updated during a write operation with the data identifier value associated with the data currently being written to the optical medium. In different examples, the data identifier value can refer to a data sector identifier value or a data frame identifier value. The data identifier operates as a virtual address that identifies the resident data of that data segment. Also, the second register 510 is continually updated during a write operation with a data identifier latency value that is representative of the time that has transpired, or the number of data elements that have been written, within the current data grouping that is referenced by the current data identifier. Each time the data identifier stored in the first register 509 is set to a new value, the data identifier latency value stored in the second register 510 is reset to a reset value, for example zero. During a read operation, the data identifier latency value is incremented appropriately to reflect the time transpired or number of data elements written since the commencement of writing of the current data set identified by the current data identifier. The registers can take the form of external registers, or memory elements, or alternatively, may reside in the write control unit 502 or signal processor 506.

When an abnormal write operation occurs (step 201 of FIG. 2), the write control unit 502 deactivates the write enable signal WENA. At the same time, the data identifier value presently stored in the first register 509 is copied to the data identifier start register 511, and the data identifier value latency value presently stored in the second register 510 is copied to the data identifier latency start register 512 (step 203 of FIG. 2). The content of the data identifier start register 511 and the data identifier latency start register 512 are later used by the comparator 505 and the write control unit 502 during a writing operation recovery procedure to determine the precise location on the electronic medium at which to recommence the writing operation.

During a subsequent read operation, performed to recover the abnormally interrupted writing operation (step 204 of FIG. 2), data that are read from the optical medium are processed by the data identifier decoder 504. The data identifier decoder 504 reviews data that are read from the optical medium 501, and decodes data identifier information from the data (step 205 of FIG. 2). The data identifier information read from the optical medium 501 is compared at comparator 505 with the value stored in the data identifier start register 511 (step 206 of FIG. 2). Assuming a match, additional data are read from the medium 501, and the number of data elements read during the read operation are tracked or counted (step 207 of FIG. 2). When the number of data elements read during the read operation equals the value stored in the data identifier latency start register 512 (step 208 of FIG. 2), the write control unit 502 responds by activating the write enable signal WENA, and the write/reproduction unit 513 recommences the previously interrupted write operation at the precise location on the medium where the operation had been interrupted (step 209 of FIG. 2).

In this manner, the precise physical location at which the write operation was interrupted can be identified and the write operation can be recovered at that location on the basis of the combination of a data identifier value and a data identifier latency value of the last valid location written.

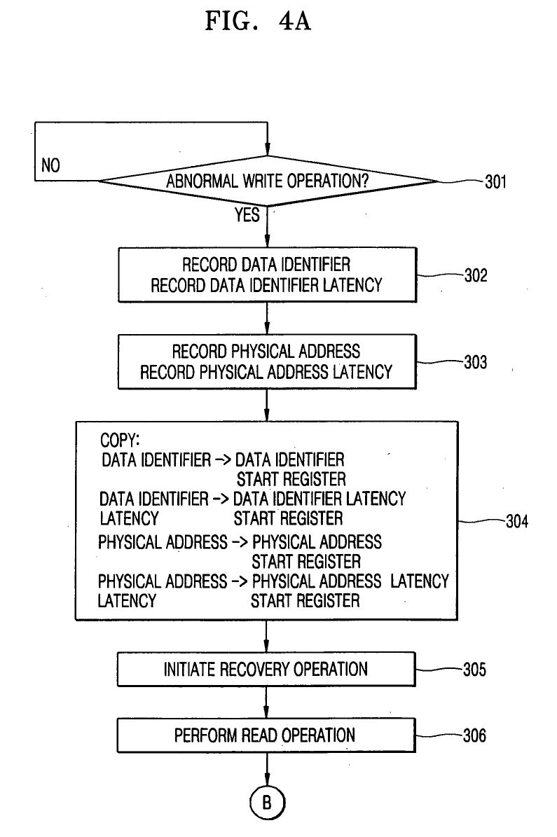

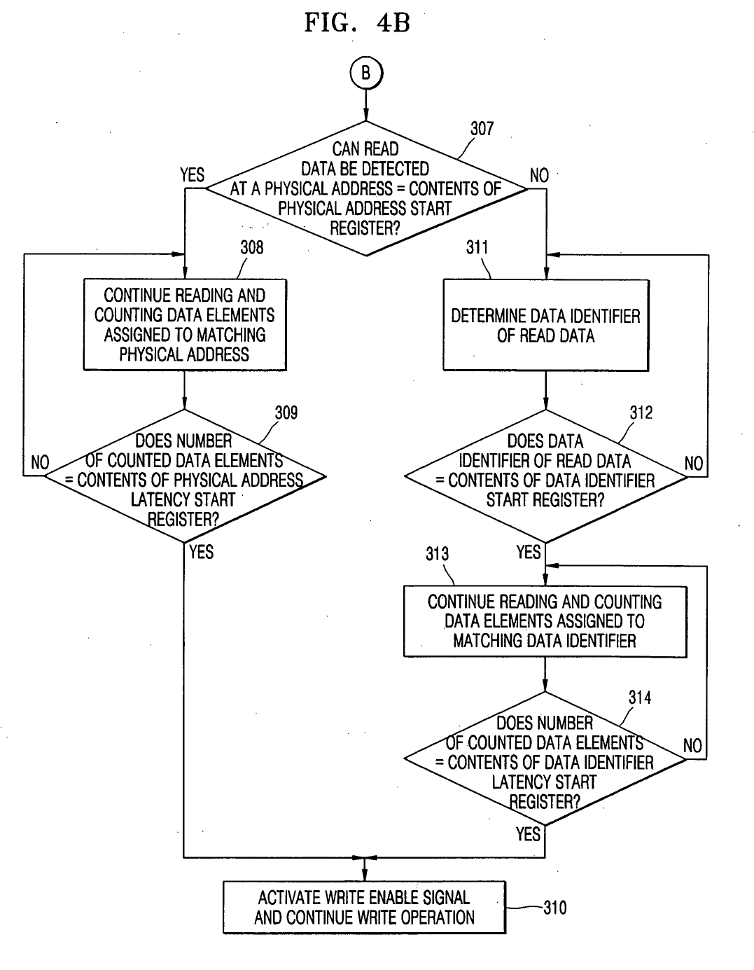

FIG. 4 is a flow diagram of a writing operation of an optical medium writing apparatus, illustrating abnormal halting of a write operation, recording of the data identifier and data identifier latency value, recording of the physical address and the physical address latency value, and recovery of the write operation using the same, in accordance with a second embodiment of the present invention.

At step 301, an abnormal write operation is detected, for example by premature deactivation of the write enable signal. At step 302, the data identifier value and the data identifier latency value are recorded. At step 303, the physical address value and the physical address latency value are recorded.

At step 304, the data identifier value and the data identifier latency value are copied to a data identifier start register and a data identifier latency start register, for later reference during a data write recovery operation. Also the physical address value and the physical address latency value are likewise copied to a physical address start register and a physical address latency start register, for later reference during the data write recovery operation.

At step 305, a data write recovery operation is initiated in order to recover the data write operation that was abnormally interrupted. The data write recovery operation attempts to recover the write operation at the location on the medium corresponding to the information recorded in physical address start register, the physical address latency start register, the data identifier start register and the data identifier latency start register. In this manner, the precise physical location at which the write operation was interrupted can be identified and the write operation can be recovered at that location on the basis of two independent parameters, a first being a combination of the physical address of the last valid location and a physical address latency value and a second being a combination of the data identifier value of the last valid location and a data identifier latency value.

At step 306, a read operation of the medium, referred to sometimes as a “re-read” operation, is performed, for example, beginning at the first physical location of the medium. At step 307, the read operation attempts to locate read data on the medium having a physical address matching that of the value stored in the physical address start register. If a match is found, then the read operation continues and the number of data elements read since the matching physical address was encountered is tracked at step 308. At step 309, the number of data elements read since the matching physical address was encountered are counted until the number matches the value stored in the physical address latency start register. When this occurs, the writing apparatus has properly located the position at which the write operation was abnormally halted. With reference to step 310, the write enable signal is then re-activated and the write operation is continued, leading to a successful recovery of the write operation.

If, at step 307, a matching physical address is not found, then the read operation continues and a data identifier of the currently read data is determined at step 311. At step 312, the recorded data are read until the data identifier of the currently read data matches the value stored in the data identifier start register. When this occurs, the read operation continues, and the number of data elements read since the matching data identifier was encountered is tracked at step 313. At step 314, the number of data elements read since the matching data identifier was encountered are counted until the number matches the value stored in the data identifier latency start register. When this occurs, the writing apparatus has properly located the position at which the write operation was abnormally halted. With reference to step 315, the write enable signal is then re-activated and the write operation is continued, leading to a successful recovery of the write operation.

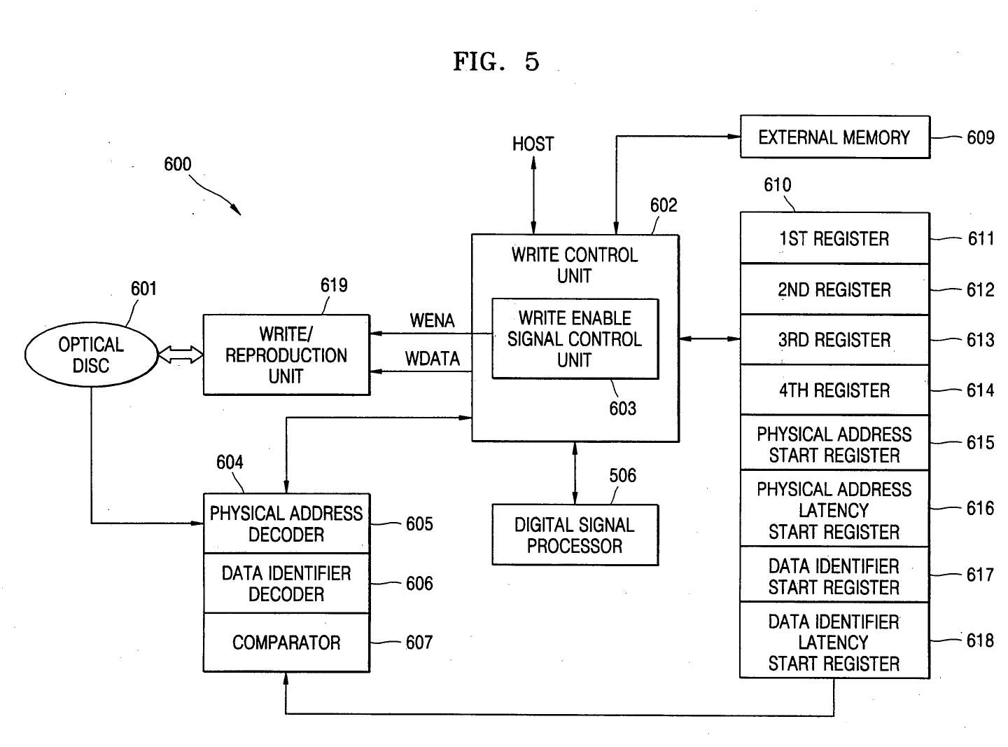

FIG. 5 is a block diagram of an optical medium writing apparatus for performing a writing operation on an optical medium, for example the writing operation of FIG. 4, in accordance with the present invention. The writing apparatus 600 includes a write control unit 602, and supporting digital signal processor 506. The write control unit 602 receives commands from and sends results to a host computer HOST. Data are written to and retrieved from an external memory unit 609 that operates as a data buffer for the apparatus 600.

A write/reproduction unit 619 including a data encoder and laser driver is responsive to signals generated by the write control unit 602 for writing data to the optical medium 601. The write control unit includes a write enable signal control unit 603 that generates a write enable signal WENA, also referred to in the art as a “write gate” signal. The write enable signal WENA is active when data are available for writing to the optical medium 601 and when the system is fully operational. When an abnormality occurs during a write operation, such as an abnormality of the type discussed above, the write enable signal WENA is inactivated, and a recovery operation is initiated, as discussed above. Data to be written to the optical medium 601 are forwarded to the write/reproduction unit 619 from the write control unit 602 via data lines WDATA when the write enable WENA signal is active.

A plurality of registers 610 interfacing with the write control unit 602 and digital signal processor 506 include a first register 611, a second register 612, a third register 613, a fourth register 614, and a corresponding physical address start register 615, a physical address latency start register 616, a data identifier start register 617 and a data identifier latency start register 618. As described above with reference to the method described in FIG. 4, the first register 611 is continually updated during a write operation with the physical address value associated with the data currently being written to the optical medium 601. Also, the second register 612 is continually updated during a write operation with a physical address latency value that is representative of the time that has transpired, or the number of data elements that have been written, within the current data grouping that is referenced by the current physical address. Each time the physical address stored in the first register 611 is set to a new value, the physical address latency value stored in the second register 612 is reset to a reset value, for example zero. During a read operation, the physical address latency value is incremented appropriately to reflect the time transpired or number of data elements written since the commencement of writing of the current data set identified by the current physical address.

Similarly, the third register 613 is continually updated during a write operation with the data identifier value associated with the data currently being written to the optical medium 601. In different examples, the data identifier value can refer to a data sector identifier value or a data frame identifier value. The data identifier operates as a virtual address that identifies the resident data of that data segment. Also, the fourth register 614 is continually updated during a write operation with a data identifier latency value that is representative of the time that has transpired, or the number of data elements that have been written, within the current data grouping that is referenced by the current data identifier. Each time the data identifier stored in the third register 613 is set to a new value, the data identifier latency value stored in the fourth register 614 is reset to a reset value, for example zero. During a read operation, the data identifier latency value is incremented appropriately to reflect the time transpired or number of data elements written since the commencement of writing of the current data set identified by the current data identifier.

When an abnormal write operation occurs (step 301 of FIG. 4), the write control unit 602 deactivates the write enable signal WENA. At the same time, the physical address value presently stored in the first register 611 is copied to the physical address start register 615, the physical address latency value presently stored in the second register 612 is copied to the physical address latency start register 616, the data identifier value presently stored in the third register 613 is copied to the data identifier start register 617, and the data identifier value latency value presently stored in the fourth register 614 is copied to the data identifier latency start register 618 (steps 302 and 303 of FIG. 4). The content of the physical address start register 615, the physical address latency register 616, the data identifier start register 617 and the data identifier latency start register 618 are later used by the comparator 607 and the write control unit 602 during a writing operation recovery procedure to determine the precise location on the electronic medium at which to recommence the writing operation.

During a subsequent read operation, performed to recover the abnormally interrupted writing operation (steps 305 and 306 of FIG. 4), data that are read from the optical medium 601 are processed by the decoder unit 604 including a physical address decoder 605 and data identifier decoder 606.

Initially, a read operation is preformed to determine whether read data can be detected at a physical address on the optical medium 601 that is equal to the contents of the physical address start register 615 (step 307 of FIG. 4). This function is performed by comparing, at comparator 607, the physical address of the data read during the read operation, as decoded by the physical address decoder 605, with the contents of the physical address start register 615.

Assuming that such data can be read at that physical address, additional data are read from the medium 601, and the number of data elements read during the read operation are tracked or counted (step 308 of FIG. 4). When the number of data elements read during the read operation equals the value stored in the physical address latency start register 616 (step 309 of FIG. 4), the write control unit 602 responds by activating the write enable signal WENA, and the write/reproduction unit 619 recommences the previously interrupted write operation at the precise location on the medium where the operation had been interrupted (step 310 of FIG. 4).

Assuming that such data cannot be read at the physical address identified by the contents of the physical address start register (step 307 of FIG. 4), the data identifier decoder 606 reviews data that are read from the optical medium 601, and decodes data identifier information from the data (step 311 of FIG. 4). The data identifier information read from the optical medium 601 is compared at comparator 607 with the value stored in the data identifier start register 617 (step 312 of FIG. 4). Assuming a match, additional data are read from the medium 601, and the number of data elements read during the read operation are tracked or counted (step 313 of FIG. 4). When the number of data elements read during the read operation equals the value stored in the data identifier latency start register 618 (step 314 of FIG. 4), the write control unit 602 responds by activating the write enable signal WENA, and the write/reproduction unit 619 recommences the previously interrupted write operation at the precise location on the medium where the operation had been interrupted (step 310 of FIG. 4).

In this manner, the precise physical location at which the write operation was interrupted can be identified and the write operation can be recovered at that location on the basis of two independent parameters, a first being the combination of the physical address and the physical address latency value of the last valid location written and a second being the combination of a data identifier value and a data identifier latency value of the last valid location written. Thus, if the write operation cannot be recovered based on the recorded physical address and physical address latency value, an additional attempt can be made to recover the write operation based on the data identifier and data identifier latency value. Assuming a single-write optical medium is the subject medium for the write operation, the second option of recovery, based on the data identifier and data identifier latency, improves the chance of recovery over conventional approaches that rely exclusively on recovery based on physical address and physical address latency.

While this invention has been particularly shown and described with references to preferred embodiments thereof, it will be understood by those skilled in the art that various changes in form and details may be made herein without departing from the spirit and scope of the invention as defined by the appended claims.

What is claimed is:

1. A system for writing data to an optical medium comprising:
a write control unit that controls the writing of data segments to an optical medium arranged according to physical addresses, each data segment written to the medium having a data segment identifier and multiple data elements, the write control unit, during a write operation, tracking the data segment identifier of each data segment being written, the write control unit, when a write operation is halted, determining the data segment identifier of a last data segment written to the optical medium at the time the write operation is halted; and
an optical medium read/write unit that reads data from the optical medium and determines a data segment identifier associated with the read data, and that writes data to the optical medium in response to the write control unit;
wherein the write control unit further, following halting of a write operation, causes the read/write unit to read data from the optical medium to locate a last data segment corresponding to the data segment identifier written to the optical medium at the time the writing operation was halted, and recommences writing of data segments to the optical medium at the located last data segment.

2. The system of claim 1 wherein the data segments comprise data frames.

3. The system of claim 1 wherein the data segments comprise data sectors.

4. The system of claim 1 wherein the data elements comprise data bits of the data segments.

5. The system of claim 1 further comprising a register that stores the data segment identifier at the time the write operation is halted.

6. The system of claim 1 further comprising a comparator that compares the data segment identifier stored in the register with data segment identifiers read from the optical medium by the read/write unit to locate the last data segment written to the optical medium.

7. The system of claim 1 wherein the write control unit, during a write operation, tracks a data segment latency value representative of the number of data elements of the data segment written relative to the current data segment identifier, and wherein the write control unit, when the write operation is halted, determines the data segment latency value of the last data element written to the optical medium at the time the writing operation is halted.

8. The system of claim 7 wherein the write control unit, following halting of the write operation, further recommences the writing of data segments to the optical medium based on the data segment latency value relative to the data segment identifier of the last data segment.

9. The system of claim 7 further comprising a register that stores the data segment latency value.

10. The system of claim 1 wherein the write control unit includes a write enable signal control unit that enables a write enable signal when a write operation is being conducted, and disables the write enable signal when a write operation is halted.

11. The system of claim 1, wherein the write control unit, during a write operation, further tracks a physical address of each data segment being written and a physical address latency value representative of the number of data elements of the data segment written relative to the current physical address, and wherein the write control unit, when the write operation is halted, determines the physical address of the last data segment written to the optical medium at the time the writing operation is halted.

12. The system of claim 11 wherein the write control unit, following halting of the write operation, further recommences the writing of data segments to the optical medium based on the physical address latency value relative to the physical address of the last data segment.

13. The system of claim 11 further comprising a register that stores the physical address latency value.

14. The system of claim 1 wherein the write operation is halted due to an abnormality or interruption of the write operation.

15. A method for writing data to an optical medium comprising:
writing data segments to an optical medium arranged according to physical addresses, each data segment written to the medium having a data segment identifier and multiple data elements;
tracking the data segment identifier of each data segment being written;
when a write operation is halted, determining the data segment identifier of a last data segment written to the optical medium at the time the write operation is halted;
following halting of the write operation, reading data from the optical medium and determining a data segment identifier associated with the read data to locate a last data segment corresponding to the data segment identifier written to the optical medium at the time the writing operation was halted; and
recommencing writing of data segments to the optical medium at the located last data segment.

16. The method of claim 15 wherein the data segments comprise data frames.

17. The method of claim 15 wherein the data segments comprise data sectors.

18. The method of claim 15 wherein the data elements comprise data bits of the data segments.

19. The method of claim 15 further comprising comparing the data segment identifier of the last data segment written to the optical medium with data segment identifiers read from the optical medium to locate the last data segment written to the optical medium.

20. The method of claim 15 further comprising, during a write operation, tracking a data segment latency value representative of the number of data elements of the data segment written relative to the current data segment identifier, and when the write operation is halted, determining the data segment latency value of the last data element written to the optical medium at the time the writing operation is halted.

21. The method of claim 20 further comprising, following halting of the write operation, further recommencing the writing of data segments to the optical medium based on the data segment latency value relative to the data segment identifier of the last data segment.

22. The method of claim 15 wherein a write enable signal is enabled when a write operation is being conducted, and wherein the write enable signal is disabled when a write operation is halted.

23. The method of claim 15, further comprising, during a write operation, tracking a physical address of each data segment being written and a physical address latency value representative of the number of data elements of the data segment written relative to the current physical address, and when the write operation is halted, determining the physical address of the last data segment written to the optical medium at the time the writing operation is halted.

24. The method of claim 23 further comprising, following halting of the write operation, recommencing the writing of data segments to the optical medium based on the physical address latency value relative to the physical address of the last data segment.
